(19) United States
(12) Patent Application Publication
(10) Pub. No.: US 2026/0170723 A1
(43) Pub. Date: Jun. 18, 2026

(54) VISUAL CONTENT REDACTION FOR CONTENT CAPTURES

(71) Applicant: MICROSOFT TECHNOLOGY LICENSING, LLC, Redmond, WA (US)

(72) Inventors: William Calvin ADAMS, Bow, WA (US); Craig Anthony CASSINAT, Snohomish, WA (US); Meishan LI, Sammamish, WA (US); Jianping YIN, Sammamish, WA (US)

(21) Appl. No.: 18/982,904

(22) Filed: Dec. 16, 2024

(51) Int. Cl. G06T 11/60; G06F 21/62

(52) U.S. Cl. CPC G06T 11/60; G06F 21/6245

(57) ABSTRACT

The techniques disclosed herein provide a system for redacting visual content in a content capture to prevent consumption by artificial intelligence models. With the advent of artificial intelligence models that can receive inputs of differing types and accordingly take various actions, productivity tools such as user activity recall systems have benefitted from increased utility including categorizing content captures and building searchable activity histories. However, given the degree of access an artificial intelligence model may require for enabling such features, it is beneficial for users to configure what visual content is available for consumption by artificial intelligence models. As such, a user can manage a content privacy setting within an application window to redact the visual content therein and prevent consumption by an artificial intelligence model via a content capture. In various examples, redacting visual content includes rendering a blank application window and selectively obscuring specific visual content objects.

### BACKGROUND

More of daily life occurs through computing devices, from completing assignments for work and school, to planning vacations and online shopping. As such, a user may utilize a diverse array of software applications to accomplish various tasks. Moreover, a given software application can be transformed by different contexts. For instance, an internet browser can be utilized to look up nearby restaurants at one moment and research information for a presentation at another moment. Consequently, the user may lose track of what they were doing at a given moment as well as the context of that activity. To aid users in retracing their steps, many software applications include features for searching and retrieving content and/or activity, such as the browsing history in an internet browser and/or a listing of recent files in a file explorer.

However, existing features such as keyword-based searches, folder hierarchies, and application-specific organization tools may lack the ability to record context and decipher user intent. For example, a user may attempt a keyword search to recover a source of information for citation in a presentation. Unfortunately, the lack of specificity in existing approaches may prevent the user from finding the information for which they are looking. Moreover, such features place an additional burden on the user to remember exact details about their past activity such as the name of a website, title of an article, or other information. Manual recollection can be especially challenging due to the sheer amount of information the user generates and interacts with. That is, many existing systems place the onus on the user to spend time manually organizing, categorizing, and documenting information rather than accomplishing the tasks they wish to complete.

It is with respect to these and other considerations that the disclosure made herein is presented.

### SUMMARY

The techniques presented herein provide a system for redacting visual content in a content capture, such as to prevent consumption by an artificial intelligence model. As mentioned above, organizing and recalling past activity in modern computing devices may be untenable for many users due to the sheer volume of applications and/or activities a user can engage in on a daily basis. Recent developments in end user experiences have streamlined activity recall operations by collecting a record of user activity such as a content capture (e.g., a screenshot) of a desktop environment. In various examples, the content capture is a composite of visual content retrieved from one or more application windows within the desktop environment. In this way, content captures enable an accurate recollection of moments of interest in past user activity thereby enhancing user engagement and productivity. In addition, content captures can be grouped in an interactive user interface that enables users to view organized collections of content captures based on shared attributes (e.g., a common topic, a common application).

Oftentimes, such user experiences are enabled through artificial intelligence models (e.g., agents) such as small language models and/or large language models that analyze visual content. That is, recent advances in the field have expanded support for input modalities beyond text (e.g., image inputs, audio inputs) and given rise to artificial intelligence models that can receive inputs of differing types and take various actions accordingly. In the context of the present disclosure, such actions include categorizing content captures, enabling a searchable user activity history, providing suggestions based on trends in user activity, and the like. However, given the degree of access an artificial intelligence model may require for enabling such features, it is beneficial to enable users to configure what visual content is available for consumption by artificial intelligence models.

While many operating systems and/or applications support data privacy and security tools such as digital rights management, such tools may not be readily accessible and/or applicable in the context of artificial intelligence models. Stated another way, artificial intelligence systems typically lack options for users to selectively prevent certain visual content objects from being consumed. Consequently, such artificial intelligence systems, which often rely on an ever-increasing volume of input data, may compromise the privacy and/or security of user data such as financial information, a home address, phone numbers, sensitive documents, and the like. For example, consider an activity recall system that records a user's activity by generating a content capture of the user's desktop environment at regular intervals (e.g., every thirty seconds). In the event the user is viewing sensitive information (e.g., an account number in online banking), the recall system may capture and save all information displayed on the user's desktop, including the sensitive information. Even in systems that maintain all content captures locally and do not transmit content captures off-device (e.g., to a cloud service), an artificial intelligence model nonetheless consumes sensitive information and may leave it vulnerable to misuse.

In contrast, the system presented herein enables a user to selectively privatize application windows in a desktop environment, such as to prevent consumption by artificial intelligence models, through visual content redaction. Within the context of the present disclosure, “privatize” refers to enabling a content privacy setting to prevent the capture of content within an application window—and, therefore, in some examples, subsequent consumption by an artificial intelligence model—and is not to be construed as privatization in the context of business operations. Generally described, the system receives a command to generate a content capture. In various examples, the content capture is an image depicting the desktop environment including one or more application windows in which each application window includes a display of visual content (e.g., a website, multimedia, text).

In response to the command to generate the content capture, the system retrieves the displays of visual content of each of the application windows within the desktop environment. In a specific example, this is achieved by querying each of the application windows. More specifically, the system queries a render buffer of each application window that defines the display of visual content. An individual render buffer defines what visual content is displayed within the associated application as well as the manner in which the visual content is displayed (e.g., a format of display).

The system can detect when a content privacy setting has been applied to an individual application window (e.g., the user has privatized the application window). As will be described below, the present system can provide several options through which a user can enable such content privacy settings. In one example, the user opens a context menu within the application window to toggle the content privacy setting on or off. In another example, the user places an icon associated with the application window in a separate task bar to toggle the content privacy setting on or off. Moreover, an application window to which the content privacy setting has been applied can be visually enhanced to communicate the current privacy status. For instance, a private application window can be rendered in a different format or with a different attribute compared to non-private application window (e.g., with a diffuse glow on the border). This informs the user that visual content within the private application window is being and/or will be redacted in content captures. Furthermore, certain types of application windows can be configured to automatically enable content privacy settings by default (e.g., web browsers, health applications, financial applications).

Accordingly, the system redacts the visual content of the private application window, for example, to prevent consumption by an artificial intelligence model. In various examples, visual content redaction is achieved by altering visual content objects such as blurring and/or blocking out various visual content objects. In another example, visual content is redacted by wholly removing the visual content of a private application window. That is, the private application window is depicted in the content capture as a blank application window. As such, the present system enhances data privacy and security while providing an engaging user experience by empowering users to control what visual content is recorded, such as for consumption by an artificial intelligence model.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1A illustrates an example user interface of a desktop environment for privatizing an application window via a context menu to redact visual content.

FIG. 1B illustrates an example result of privatizing an application window to redact visual content.

FIG. 2A illustrates another example user interface of a desktop environment for privatizing an application window via a split taskbar to redact visual content.

FIG. 2B illustrates another example result of privatizing an application window to redact visual content.

FIG. 3A illustrates an example of visual content redaction in which a render buffer is emptied resulting in a blank application window.

FIG. 3B illustrates an example of visual content redaction in which redaction is applied to a specific visual content object.

FIG. 4 is a block diagram of a system for redacting visual content from content captures.

FIG. 5 is a flow diagram showing aspects of a process for redacting visual content from content captures.

FIG. 6 is a computer architecture diagram illustrating an illustrative computer hardware and software architecture for a computing system capable of implementing aspects of the techniques and technologies presented herein.

### DETAILED DESCRIPTION

The techniques presented herein provide systems for redacting visual content from content captures, such as to prevent consumption by artificial intelligence models. As mentioned above, advances in the field of artificial intelligence have enabled support for diverse input types beyond text, such as images and even audio. Accordingly, in some examples, artificial intelligence models enable productivity features that utilize content captures (e.g., screenshots) of a user's desktop environment to record and generate insight into the user's activity history. However, many existing artificial intelligence systems lack mechanisms that empower users to dictate what information (e.g., visual content) is provided to the artificial intelligence model for consumption. That is, in an existing system, the user may either wholly consent to the collection of content captures or forgo the productivity features enabled by such activity. Should the user consent, content captures that are input to such artificial intelligence systems may include information that the user may otherwise wish to prevent from consumption (e.g., personal information, sensitive information).

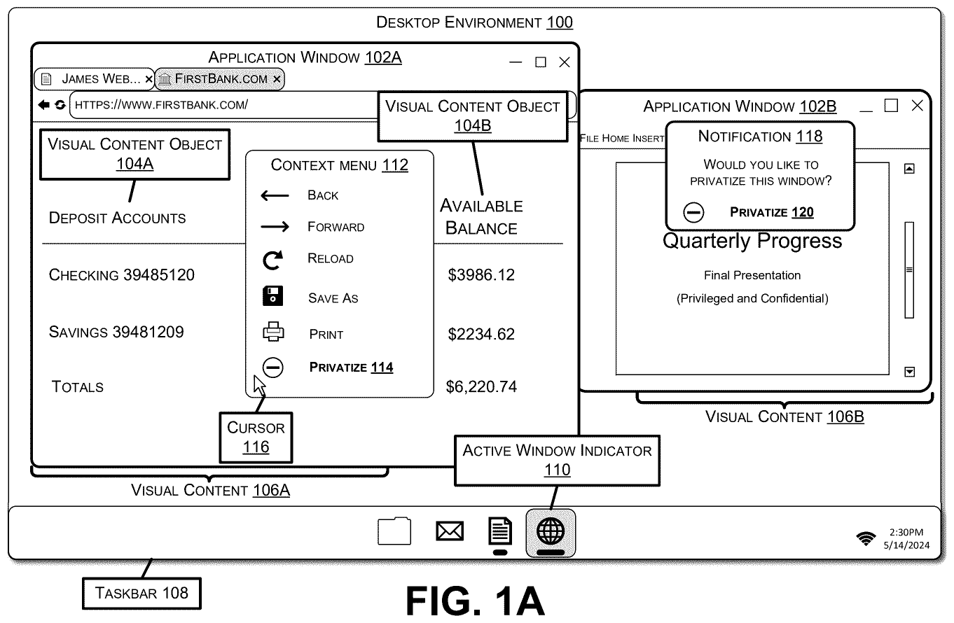

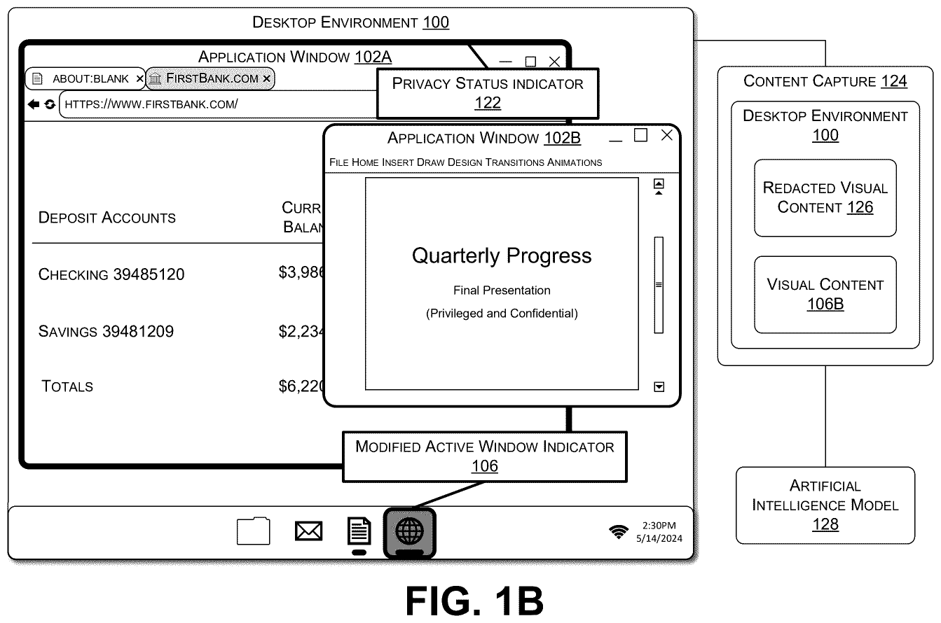

Various examples, scenarios, and aspects related to the techniques are described below with respect to FIGS. 1A-6.

FIG. 1A illustrates a desktop environment 100 displaying a plurality of application windows 102A and 102B. The first application 102A is a web browser currently displaying a webpage for an online banking system. As shown, the application window 102A includes visual content objects 104A and 104B displaying a bank account number and an available account balance respectively. Collectively, the visual content objects 104A and 104B form a display of visual content 106A of the first application window 102A. In addition, the desktop environment 100 includes a taskbar 108 containing an active window indicator 110 that is associated with the application 102A.

Naturally, the user may wish to prevent sensitive financial information such as account numbers from being recorded in a content capture and subsequently consumed by an artificial intelligence model. While the artificial intelligence model itself may be configured to avoid divulging such information, the content capture is nonetheless preserved in storage and may be vulnerable to misuse. In the event of an unforeseen security breach or other incident, unscrupulous actors may obtain the sensitive information. Accordingly, the user can activate a context menu 112 within the application window 102A to privatize 114 the application window 102A. In various examples, the user activates the context menu 112 using a cursor 116 (e.g., a right click input). In another example, the user can activate the context menu 112 using a touch input (e.g., a long press) or any other suitable input such as voice, keyboard shortcuts, and the like.

Generally described, the context menu 112 is a user interface element that includes options associated with the current context of the application window 102A. In a web browser, for example, the context menu 112 may include options for going back, going forward, and reloading the webpage. As will be elaborated below, upon selecting a privatize option 114, the application window 102A transitions into a private application window. That is, the user toggles a content privacy setting for the application window 102A by selecting the privatize option 114. In various examples, the privatize option 114 is enabled by default based on the application type of the application window 102A (e.g., a web browser, a healthcare application, a financial application).

In another example, consider a second application window 102B which includes its own display of visual content 106B. In this example, the operating system may determine that a user is likely viewing and/or interacting with sensitive information in application window 102B. For instance, the operating system can utilize textual and/or other analysis of the visual content 106B to identify context (e.g., a financial context) and calculate the probability that the user is viewing sensitive information. In a specific example, the visual content 106B is processed by an optical character recognition tool and then analyzed by a natural language processing tool to identify sensitive content. In response, the application window 102B renders a notification 118 presenting the user with the option to privatize 120 the application window 102B. In the event the user selects the privatize option 120, the application 102B will transition to a private application window. In addition, the notification 118 may also enable the user to optionally apply the privacy setting to the specific application window 102B or persist the privacy setting across other applications windows of the same application (e.g., a web browser, a slide deck editor). For example, when a user is first prompted to privatize an application window, the user may receive an option to “always” privatize application windows this application or privatized the application window 102B “this time only.”

For the sake of continuing the present discussion, consider an example in which the user enables the first privatize option 114 in the context menu 112 of the first application window 102A and not the second privatize option 120 in the notification 118 of the second application window 102B. That is, the content privacy setting for the first application window 102A is enabled while the content privacy setting for the second application 102B is not enabled.

Turning now to FIG. 1B, the first application window 102A is rendered with a privacy status indicator 122 that visually communicates the current status of the content privacy setting of the first application window 102A. In the present example, the content privacy setting for the first application window 102A is enabled resulting in the privacy status indicator 122 indicating that the first application window 102A is a private application window. In some examples, the privacy status indicator 122 is a modified presentation format for an application window (e.g., modified compared to a normal or standard presentation format). For example, the modified presentation format can be reflected in the window border for the first application window 102A via a diffuse glow effect, altered color scheme, thickened edges (as illustrated), or any other suitable mechanism that communicates the current status of the content privacy setting for the first application window 102A.

Moreover, in various examples, the user can configure privacy settings of a private application window 102A to extend across other application windows that are opened from the private application window 102A. That is, application windows that are opened from the private application window 102A can inherit the active privacy setting and are accordingly rendered with the privacy status indicator 122. Conversely, the user may choose a configuration such that application windows that are opened from the private application window 102A do not inherit the privacy setting.

Conversely, as mentioned above, the content privacy setting for the second application window 102B is not enabled. As such, the presentation of the second application window 102B is not modified (from a normal presentation format). However, while the privacy status indicator 122 of the present example indicates that the privacy setting is enabled, it should be understood that, in other examples, the privacy status indicator 122 can indicate that the privacy setting is disabled. That is, the visual content therein is available for inclusion in a content capture and, therefore, subsequent consumption by an artificial intelligence model.

Subsequently, an operating system component (e.g., an activity recall system) generates a content capture 124 of the desktop environment 100. In a specific example, the content capture 124 is generated in response to an automatic trigger as part of a user activity recording feature. In another example, the content capture is generated via a manual trigger (e.g., a snipping tool). In various examples, the content capture 124 is generated by querying each of the application windows 102A and 102B for the corresponding visual content 106A and 106B. The visual content 106A and 106B is then composited into a final image of the desktop environment 100. However, rather than return the visual content 106A depicting the bank account numbers, the first application window 102A returns redacted visual content 126 for the content capture 124. As will be discussed below, the redacted visual content 126 can be achieved in various ways such as returning a blank application window 102A, targeted redaction of specific visual content objects, and so forth. Subsequently, the content capture 124 may be input to an artificial intelligence model 128 for analysis. In various examples, the artificial intelligence model 128 is a small language model and/or large language model that is configured to analyze the content capture 124 to enable some or all of the productivity features mentioned above such as categorization, activity insight, searchable user activity history, and the like.

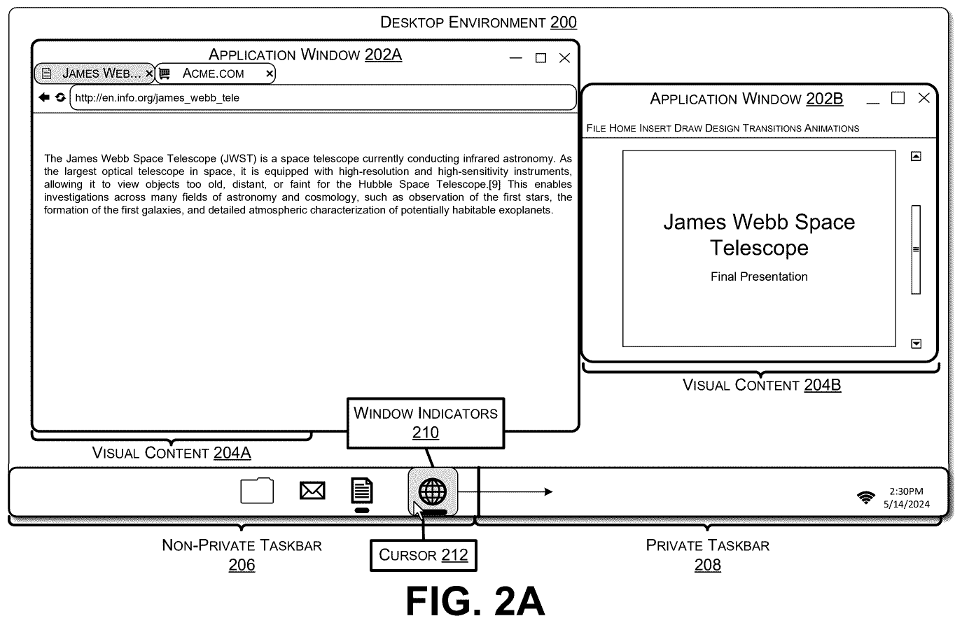

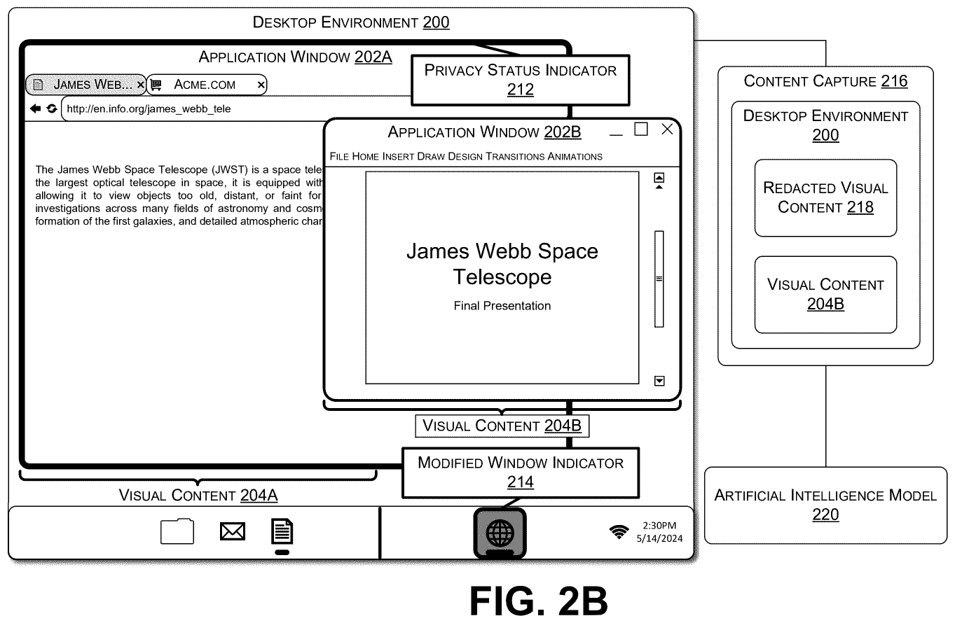

Turning now to FIG. 2A, aspects of another example of a desktop environment 200 utilizing a visual content redaction system are shown and described. In the present example, a user has opened a first application window 202A (e.g., a web browser) to view information on the James Webb Space Telescope. In a second application window 202B, the user is working on a slide deck presentation on the James Webb Space Telescope. Similar to the previous example discussed above with respect to FIGS. 1A and 1B, each application window 202A and 202B includes a respective display of visual content 204A and 204B. In contrast to the above examples however, the desktop environment 200 includes a split taskbar comprising a non-private taskbar 206 and a private taskbar 208. As shown, the non-private taskbar 206 operates similarly to a conventional taskbar by displaying window indicators 210 comprising icons representing the application windows 202A and 202B. A user can freely relocate window indicators 210 between the non-private taskbar 206 and the private taskbar 208. In a specific example, the user utilizes a cursor 212 to click and drag one of the window indicators 210 corresponding to the application window 202A from the non-private taskbar 206 to the private taskbar 208. In response, the application window 202A transitions to a private application window in which the visual content 204A will be redacted in content captures. In this way, the private taskbar 208 is a designated area within the desktop environment in which the user can place a window indicator 210 associated with the application window 202A to enable a content privacy setting.

Turning now to FIG. 2B, in response to the user moving one of the window indicators 210 corresponding to the first application window 202A to the private taskbar 208, the rendering of the application window 202A is modified to include a privacy status indicator 212. Similar to the examples described above, the privacy status indicator 212 is a visual format modification of an application window 202A that communicates a current status of the content privacy setting for the application 202A. In various examples, the privacy status indicator 212 is a diffuse glow effect, an altered color scheme, a thickened window edge (as illustrated) or any other suitable method that communicates the current status of the content privacy setting for the application window 202A. In addition, in the illustrated example, the selected one of the window indicators 210 transitions into a modified window indicator 214 that likewise communicates the current status of the content privacy setting of the first application window 202A. In contrast, the rendering of the second application window 202B remains unchanged as the window indicator for the second application window 202B remains on the non-private taskbar 206.

Subsequently, a component of the operating system (e.g., a user activity recall system) generates a content capture 216 of the desktop environment 200 by querying each of the application windows 202A and 202B for their respective visual content 204A and 204B. However, due to the current status of the content privacy setting of the first application window 202A, rather than pass the unredacted visual content 204A, the application window 202A provides a redacted visual content 218 for the content capture 216. As will be described below, the redacted visual content 218 can be generated in various ways such as removing all of the visual content 204A, selectively redacting individual visual content objects, and the like. Conversely, the second application window 202B provides the unredacted visual content 204B for the content capture 216 as the content privacy setting is not enabled for the second application window 202B. Accordingly, the content capture 216 is stored, for example, for subsequent input to an artificial intelligence model 220 to enable the productivity features mentioned above.

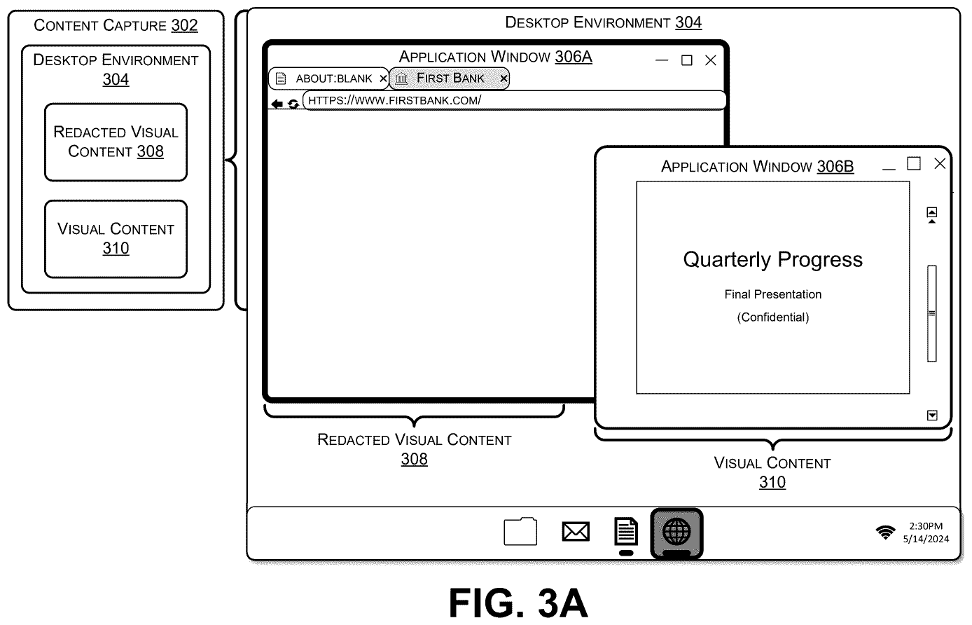

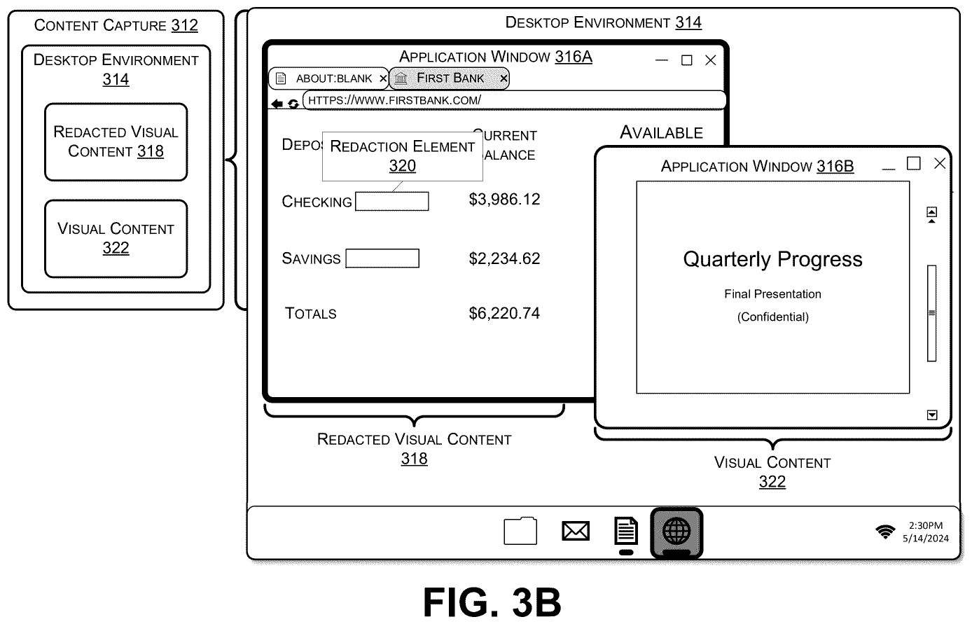

Proceeding now to FIG. 3A, aspects of a first example of a visual content redaction approach are shown and described. As shown, a content capture 302 depicts a desktop environment 304 that contains a first application window 306A and a second application window 306B. However, the first application window 306A is rendered blank within the content capture 302, for example, with redacted visual content 308, pursuant to the content privacy setting that prevented the original visual content of the first application window 306A from being recorded. Conversely, the second application window 306B does not have the content privacy setting enabled and thus is rendered within the content capture 302 with its original visual content 310.

In various examples, this is accomplished by returning an empty render buffer in response to a visual content query. In a specific example, the operating system rendering the desktop environment invokes an operating system-level (e.g., native) digital rights management tool to generate the redacted visual content 308. As will be elaborated upon further below, each of the application windows 306A and 306B can have an associated render buffer that defines the visual content display of each application window 306A and 306B. Accordingly, these render buffers are queried to retrieve visual content for compositing into the content capture 302. In addition, it should be understood that while some information such as a website address and/or browser tab information is displayed as illustrated in the example of FIG. 3A, such information may also be redacted.

Turning now to FIG. 3B, aspects of a second example of a second visual content redaction approach are shown and described. Similar to the above example, a content capture 312 depicts a desktop environment 314 containing a first application window 316A and a second application window 316B. Likewise, a content privacy setting is applied to the first application window 316A resulting in a redacted visual content 318. However, unlike the example of FIG. 3A, the redacted content 318 is selectively redacted using a redaction element 320 to obscure specific visual content objects. In the present example, the redaction element 320 obscures the account numbers of a checking and a savings account while leaving other visual content objects such as account balances unredacted. In various examples, redaction elements 320 can be presented as suggested redactions which the user can optionally approve and/or remove. Moreover, the user may also be empowered to manually place a redaction element 320. Conversely, a content privacy setting is not applied to the second application window 316B and therefore its visual content 322 is displayed unredacted. In a specific example, the redaction element 320 is rendered as a block similar to the example illustrated in FIG. 3B. In another example, the redaction element 320 is a blur effect that obscures the visual content object underneath. However, it should be understood that any suitable method for redacting visual content can be utilized such as emptying a render buffer, applying a visual blur effect, and so forth.

Redacting visual content 318 in this way enables the content capture 312 to be stored and/or rendered in a manner that prevents sensitive information such as bank account numbers from being recorded and/or consumed by an artificial intelligence model while still enabling a recording of user activity. That is, a user can view the content capture 312 at a later point in time and understand that the desktop environment was displaying an online banking application in a web browser and a slide deck presentation. However, due to the redaction element 320, sensitive and/or potentially compromising information such as bank account numbers are not present in the content capture 312. As such, this information is not available for consumption by an artificial intelligence model, nor will this information be available to malicious actors in the event the content capture 312 is obtained unscrupulously.

It should be understood that the redaction methods illustrated in FIGS. 3A and 3B can be used interchangeably and/or in tandem to suit various data privacy needs and/or configurations. For example, an individual application (e.g., a web browser) can implement mechanisms for privatizing visual content such as the partial redaction illustrated in FIG. 3B. Such application-level mechanisms can supersede operating system-level mechanisms that fully redact the application window as illustrated in FIG. 3A. Accordingly, the application window privatization system as presented herein can utilize a hierarchical flow when redacting visual content in a private application window. If the application rendering the private application window is configured to control content redaction, the system allows the application to redact content and does not render a blank application window. The partially redacted visual content can then be queried for composition into content captures. If the application is not configured to control content redaction, a blank application window is rendered and subsequently composited into the desktop in content captures. Naturally, if the application window is not private, the visual content is not modified.

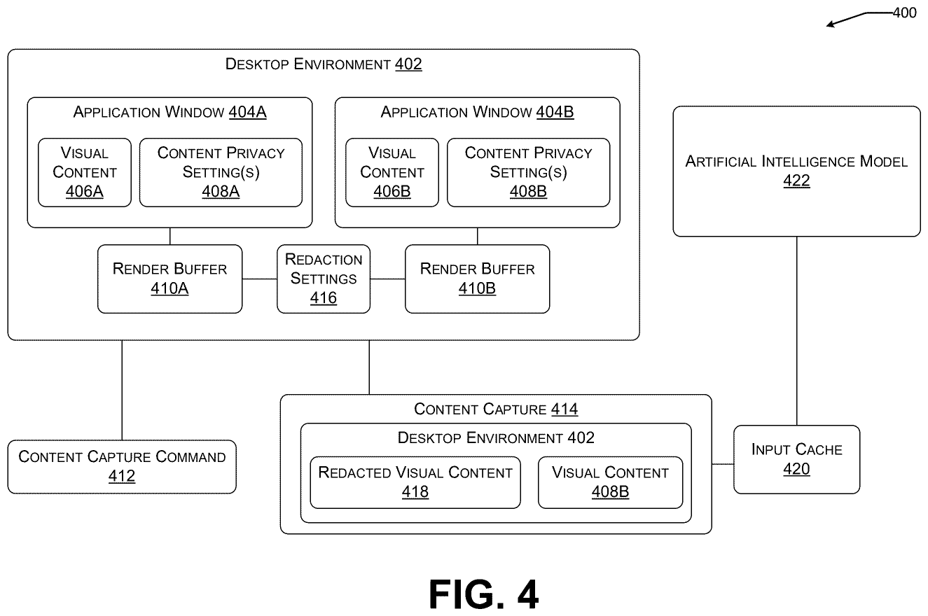

Turning now to FIG. 4, aspects of a system 400 for redacting visual content to prevent consumption by an artificial intelligence model are shown and described. In various examples, the system 400 is an information management system that is implemented as a native component of an operating system that likewise provides a desktop environment 402, and thus, the system 400 is configured to manage the content displayed within and/or extracted from the desktop environment 402. As shown, the desktop environment 402 includes a first application window 404A and a second application window 404B. Each of the application windows 404A and 404B include a respective display of visual content 406A and 406B as well as a respective content privacy setting 408A and 408B. As such, visual content 406 and content privacy settings 408 are managed on a per-application window 404 basis. Likewise, each application window 404A and 404B is configured with a corresponding render buffer 410A and 410B, respectively. Generally described, a render buffer 410A is a data resource that defines the display of visual content 406A for an associated application window 404A. In addition, it should be understood that, while the examples discussed herein involve two application windows 404A and 404B, the desktop environment 402 can display any number of application windows (e.g., three, ten, twenty).

Accordingly, the system 400 can process an incoming content capture command 412 for generating a content capture 414 depicting the desktop environment 402. In the present example, consider a situation in which the content privacy setting 408A of the first application window 408A is enabled while the content privacy setting 408B of the second application window 404B is disabled. That is, the visual content 406A will be redacted, for example, to prevent consumption by artificial intelligence models while the visual content 406B will not be redacted. As such, the system 400 applies one or more redaction settings 416 to the render buffer 410A of the first application window 404A in accordance with the content privacy setting 408A and does not apply the redaction settings 416 to the render buffer 410B of the second application window 404B.

In various examples, the redaction settings 416 define a content redaction approach that is utilized when redacting the visual content 406A such as emptying the render buffer as described above with respect to FIG. 3A, selectively redacting specific visual content objects as described above with respect to FIG. 3B, applying a watermark, or any other suitable approach for redacting the visual content 406A to prevent consumption by artificial intelligence models. Moreover, the redaction settings 416 can be user-configured to utilize a preferred redaction approach. For example, a user desiring maximum privacy can configure the redaction settings 416 to empty the render buffer 410A resulting in a blank application window 404A to be depicted in the content capture 414. In another example, a user that aims to maintain a record of their activity history while removing specific pieces of sensitive information can apply a redaction setting 416 to selectively redact the visual content 406A. Alternatively, the redaction settings 416 can be configured on an individual application basis. As mentioned above, partial redaction of the visual content 406A can be handled by the application rendering the application window 404A (e.g., a web browser) whereas full redaction of the visual content via emptying the render buffer 410A is managed by the operating system. As such, the system 400 can defer to individual applications for partial redaction before then defaulting to the operating system for full redaction.

Moreover, in various examples, the redaction settings can be adjusted based on the level of sensitivity of the visual content 408A which can likewise be user-configured. For example, the content privacy settings 408A can include settings for “highly sensitive” content and “sensitive” content. Accordingly, a “highly sensitive” content privacy setting 408A can result in a redaction setting 416 that empties the render buffer 410A to fully redact the visual content 406A. Alternatively, a “sensitive” content privacy setting 408A can result in a redaction setting that selectively redacts specific visual content objects. In addition, the content privacy setting 408A can also be disabled (e.g., “off”).

Subsequently, the system 400 queries the application windows 404A and 404B to retrieve the respective visual content 406A and 406B of each and composite into the content capture 414. In response, the second application window 404B, which does not have an active content privacy setting 408B, returns an unredacted visual content 406B. Conversely, the first application window 404A, having an active content privacy setting 408A, applies the redaction settings 416 to the render buffer 410A to redact the visual content 406A. Accordingly, the first application window 404A returns a redacted visual content 418 for composition into the content capture 414. Stated another way, applying the redaction settings 416 prevents some or all of the visual content 406A from being extracted from the desktop environment 402 via the content capture 414.

The content capture 414 is then stored in an input cache 420 in preparation for consumption by an artificial intelligence model 422. Generally described, the input cache 420 is a storage component that holds the content capture 414 for a predefined time period (e.g., thirty minutes, one day) before inputting the content capture 414 to the artificial intelligence model 422. In this way, a user can toggle a content privacy setting 408B to retroactively apply the redaction settings 416 to the visual content 406B and prevent its consumption by the artificial intelligence model 422. In a specific example, a user decides to enable the content privacy setting 408B despite one or more content captures 414 having already been generated that capture the visual content 406B of the second application window 404B. As such, the system 400 can identify any content capture 414 containing the visual content 406B that the user wishes to redact. In a specific example, the system 400 reprocesses this content capture 414 to redact its visual content 408B and replace the content capture 414 in the input cache 420. In an alternative example, the system 400 deletes said content capture 414 from the input cache 420. In another example, the input cache 420 is a user-accessible component. As such, the user can manually edit and/or delete the content capture 414 prior to consumption by the artificial intelligence model 422.

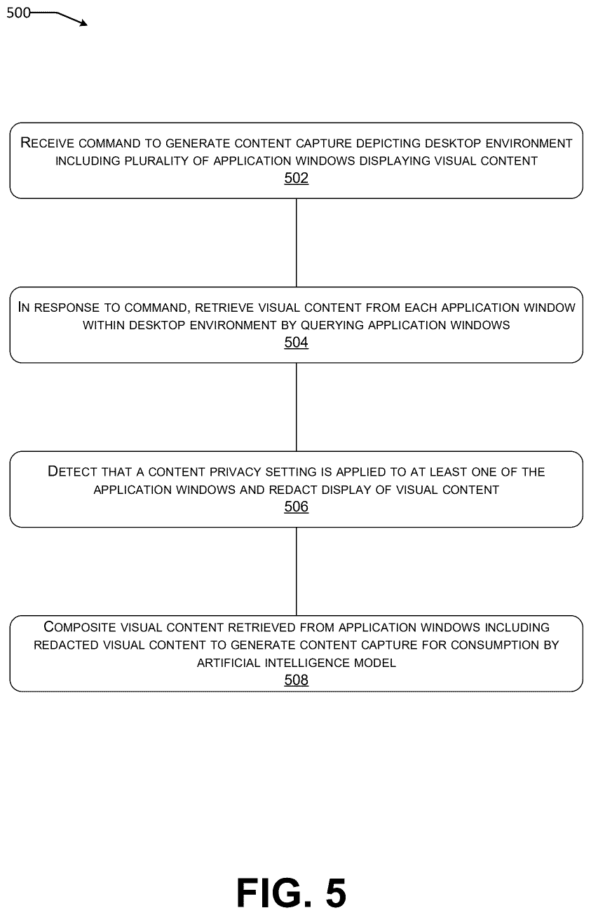

Turning now to FIG. 5, aspects of a routine 500 for redacting visual content, for example, to prevent consumption by an artificial intelligence model are shown and described. With respect to FIG. 5, the process 500 begins at operation 502 wherein an information management system receives a command to generate a content capture. Generally described, the content capture depicts a desktop environment including a plurality of application windows. Each individual application window includes a respective display of visual content therein. In a specific example, one application window is a web browser displaying an online banking application while another application window is a slide deck editor displaying a presentation as described with respect to FIGS. 1A-2B.

Next, at operation 504, in response to the content capture command, the information management system retrieves the visual content displayed by the application windows by querying each of the application windows. In a specific example, the information management system queries a respective render buffer of each application window. In general, a render buffer defines what visual content is displayed as well as the manner in which the visual content is displayed (e.g., a format).

Then, at operation 506, the information management system detects that a content privacy setting is applied to at least one of the application windows (e.g., the user enabled a privacy mode). The information management system then redacts the display of visual content within the application window having the active content privacy setting. As described above, redacting the visual content can include emptying the render buffer to cause the application window to appear blank in the content capture. In another example, redacting the visual content comprises applying redaction elements to specific visual content objects depicting sensitive information (e.g., account numbers) while leaving other visual content unredacted.

Finally, at operation 508, the information management system composites the visual content retrieved from the application windows, including the redacted visual content into a content capture, such as for consumption by the artificial intelligence model. In various examples, the artificial intelligence model is a small language model or a large language model that is configured to analyze the visual content of the content capture to identify possible topics based on textual and image data. Moreover, the content capture can be retained by the artificial intelligence model, and associated systems, for subsequent training and/or analysis. As such, enabling the user to dictate what visual content is available for consumption by the artificial intelligence model enhances information security while providing an engaging user experience.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated method can begin and/or end at any time and need not be performed in its entirety. Some or all operations of the method, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the process 500 can be implemented, at least in part, by modules running the features disclosed herein can be a dynamically linked library, a statically linked library, functionality produced by an application programing interface, a compiled program, an interpreted program, a script, or any other executable set of instructions. Data can be stored in a data structure in one or more memory components. Data can be retrieved from the data structure by addressing links or references to the data structure.

Although the illustration may refer to the components of the figures, it should be appreciated that the operations of the process 500 may also be implemented in other ways. In addition, one or more of the operations of the process 500 may alternatively or additionally be implemented, at least in part, by a chipset working alone or in conjunction with other software modules. In the example described below, one or more modules of a computing system can receive and/or process the data disclosed herein. Any service, circuit, or application suitable for providing the techniques disclosed herein can be used in operations described herein.

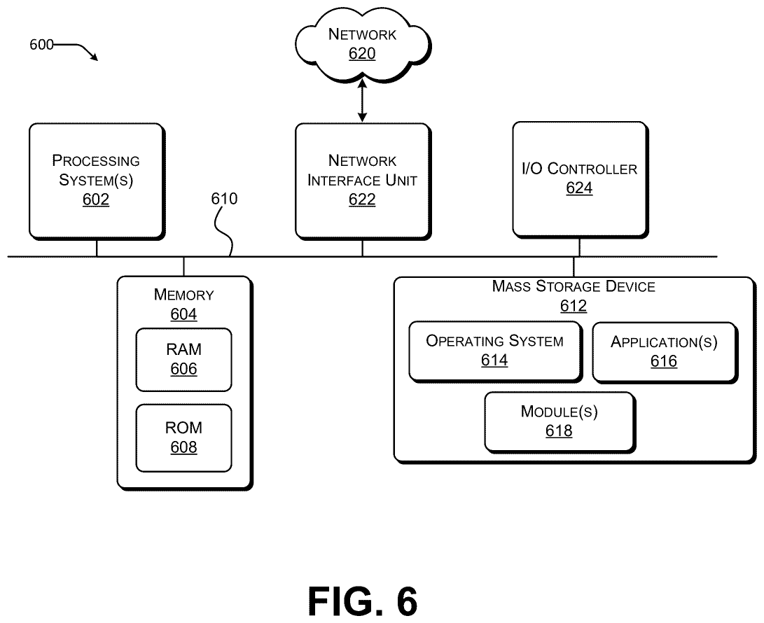

FIG. 6 shows additional details of an example computer architecture 600 for a device, capable of executing computer instructions (e.g., a module or a program component described herein). The computer architecture 600 illustrated in FIG. 6 includes processing system 602, a system memory 604, including a random-access memory 606 (RAM) and a read-only memory (ROM) 608, and a system bus 610 that couples the memory 604 to the processing system 602. The processing system 602 comprises processing unit(s).

Processing unit(s), such as processing unit(s) of processing system 602, can represent, for example, a CPU-type processing unit, a GPU-type processing unit, a field-programmable gate array, another class of digital signal processor (DSP), or other hardware logic components that may, in some instances, be driven by a CPU. For example, illustrative types of hardware logic components that can be used include Application-Specific Integrated Circuits, Application-Specific Standard Products, System-on-a-Chip Systems, Complex Programmable Logic Devices, and the like.

A basic input/output system containing the basic routines that help to transfer information between elements within the computer architecture 600, such as during startup, is stored in the ROM 608. The computer architecture 600 further includes a mass storage device 612 for storing an operating system 614, application(s) 616, modules 618, and other data described herein.

The mass storage device 612 is connected to processing system 602 through a mass storage controller connected to the bus 610. The mass storage device 612 and its associated computer-readable media provide non-volatile storage for the computer architecture 600. Although the description of computer-readable media contained herein refers to a mass storage device, the computer-readable media can be any available computer-readable storage media or communication media that can be accessed by the computer architecture 600.

Computer-readable media includes computer-readable storage media and/or communication media. Computer-readable storage media includes one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including RAM, static RAM (SRAM), dynamic RAM (DRAM), phase change memory (PCM), ROM, erasable programmable ROM (EPROM), electrically EPROM (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 600 may operate in a networked environment using logical connections to remote computers through the network 620. The computer architecture 600 may connect to the network 620 through a network interface unit 622 connected to the bus 610. The computer architecture 600 also may include an input/output controller 624 for receiving and processing input from a number of other devices, including a keyboard, mouse, touch, or electronic stylus or pen. Similarly, the input/output controller 624 may provide output to a display screen, a printer, or other type of output device.

The software components described herein may, when loaded into the processing system 602 and executed, transform the processing system 602 and the overall computer architecture 600 from a general-purpose computing system into a special-purpose computing system customized to facilitate the functionality presented herein. The processing system 602 may be constructed from any number of transistors or other discrete circuit elements, which may individually or collectively assume any number of states. More specifically, the processing system 602 may operate as a finite-state machine, in response to executable instructions contained within the software modules disclosed herein. These computer-executable instructions may transform the processing system 602 by specifying how the processing system 602 transition between states, thereby transforming the transistors or other discrete hardware elements constituting the processing system 602.

The disclosure presented herein also encompasses the subject matter set forth in the following clauses.

Example Clause A, a method for redacting visual content in a content capture, the method comprising: receiving a command to generate the content capture, wherein: the content capture depicts a desktop environment including a plurality of application windows, wherein the plurality of application windows include a private application window; and an application window includes a respective display of visual content within the application window; in response to the command, retrieving the respective displays of visual content of the plurality of application windows within the desktop environment by querying the plurality of application windows; in response to detecting a content privacy setting applied to the private application window, redacting the respective display of visual content within the private application window; and compositing the visual content retrieved from the plurality of application windows including the redacted visual content to generate the content capture.

Example Clause B, the method of Example Clause A, wherein the private application window is associated with a visual indicator communicating a status of the content privacy setting.

Example Clause C, the method of Example Clause A or Example Clause B, wherein an icon within a taskbar of the desktop environment associated with the private application window is associated with a visual indicator communicating a status of the content privacy setting.

Example Clause D, the method of any one of Example Clause A through C, wherein the content privacy setting is enabled by default for a category of software application.

Example Clause E, the method of any one of Example Clause A Through D, wherein the content privacy setting is togglable via a context menu option within the private application window.

Example Clause F, the method of any one of Example Clause A through D, wherein the content privacy setting is togglable via a user interface element that is activated in response to a user opening the private application window.

Example Clause G, the method of any one of Example Clause A through D, wherein the content privacy setting is enabled by placing an icon associated with the private application window in a designated area within the desktop environment.

Example Clause H, the method of any one of Example Clause A through G, wherein the content capture is stored in an input cache prior to consumption by an artificial intelligence model and the method further comprises additionally redacting additional visual content in response to receiving an activation of another content privacy setting associated with another one of the plurality of application windows following generation of the content capture.

Example Clause I, the method of any one of Example Clause A through H, wherein the content privacy setting is an operating system-level digital rights management utility.

Example Clause J, the method of any one of Example Clause A through I, wherein: the respective display of visual content within the application window is defined by a render buffer; retrieving the respective display of visual content of the application window comprises querying the render buffer; and redacting the respective display of visual content within the private application window comprises modifying the render buffer for the private application window.

Example Clause K, the method of Example Clause J, wherein modifying the render buffer for the private application window to redact the respective display of visual content comprises emptying the render buffer.

Example Clause L, a system for redacting visual content in a content capture, the system comprising: a processing system; and a computer-readable medium having encoded thereon that, when executed by the processing system, causes the system to perform operations comprising: receiving a command to generate the content capture, wherein: the content capture depicts a desktop environment including a private application window; and the private application window includes a display of visual content; in response to the command, retrieving the display of visual content of the private application window within the desktop environment by querying the private application window; in response to detecting a content privacy setting utilized by the private application window, redacting the respective display of visual content within the private application window; and compositing the redacted visual content to generate the content capture.

Example Clause M, the system of Example Clause L, wherein the private application window that utilizes the content privacy setting includes a visual indicator communicating a status of the content privacy setting.

Example Clause N, the system of Example Clause L or Example Clause M, wherein the content privacy setting is togglable via a context menu option within the private application window.

Example Clause O, the system of Example Clause L or Example Clause M, wherein the content privacy setting is enabled by placing an icon associated with the private application window in a designated area within the desktop environment.

Example Clause P, the system of any one of Example Clause L through O, wherein: the private application window is a first application window; the content privacy setting is a first content privacy setting; the content capture is stored in an input cache prior to consumption by an artificial intelligence model; and the operations further comprise redacting additional visual content in response to receiving an activation of a second content privacy setting associated with a second application window following generation of the content capture.

Example Clause Q, the system of any one of Example Clause L through P, wherein: the display of visual content within the private application window is defined by a render buffer; retrieving the display of visual content of the private application window comprises querying the render buffer; and redacting the display of visual content within the private application window comprises modifying the render buffer for the private application window.

Example Clause R, the system of Example Clause Q, wherein modifying the render buffer for the private application window to redact the respective display of visual content comprises emptying the render buffer.

Example Clause R, a computer-readable storage medium for redacting visual content in a content capture, the computer-readable storage medium having encoded thereon, computer-readable instructions that, when executed by a system, cause the system to perform operations comprising: receiving a command to generate the content capture, wherein: the content capture depicts a desktop environment including a plurality of application windows, wherein the plurality of application windows include a private application window; and an application window includes a respective display of visual content within the application window; in response to the command, retrieving the respective displays of visual content of the plurality of application windows within the desktop environment by querying the plurality of application windows; in response to detecting a content privacy setting utilized by a private application window, redacting the respective display of visual content within the private application window; and compositing the visual content retrieved from the plurality of application windows including the redacted visual content to generate the content capture.

Example Clause T, the computer-readable storage medium of Example Clause S, wherein the private application window that utilizes the content privacy setting includes a visual indicator communicating a status of the content privacy setting.

Conditional language such as, among others, “can,” “could,” “might” or “may,” unless specifically stated otherwise, are understood within the context to present that certain examples include, while other examples do not include, certain features, elements, and/or steps. Thus, such conditional language is not generally intended to imply that certain features, elements, and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

The terms “a,” “an,” “the” and similar referents used in the context of describing the invention (especially in the context of the following claims) are to be construed to cover both the singular and the plural unless otherwise indicated herein or clearly contradicted by context. The terms “based on,” “based upon,” and similar referents are to be construed as meaning “based at least in part” which includes being “based in part” and “based in whole” unless otherwise indicated or clearly contradicted by context.

In addition, any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method for redacting visual content in a content capture, the method comprising:
receiving a command to generate the content capture, wherein:
the content capture depicts a desktop environment including a plurality of application windows, wherein the plurality of application windows include a private application window; and
an application window includes a respective display of visual content within the application window;
in response to the command, retrieving the respective displays of visual content of the plurality of application windows within the desktop environment by querying the plurality of application windows;
in response to detecting a content privacy setting applied to the private application window, redacting the respective display of visual content within the private application window; and
compositing the visual content retrieved from the plurality of application windows including the redacted visual content to generate the content capture.

2. The method of claim 1, wherein the private application window is associated with a visual indicator communicating a status of the content privacy setting.

3. The method of claim 1, wherein an icon within a taskbar of the desktop environment associated with the private application window is associated with a visual indicator communicating a status of the content privacy setting.

4. The method of claim 1, wherein the content privacy setting is enabled by default for a category of software application.

5. The method of claim 1, wherein the content privacy setting is togglable via a context menu option within the private application window.

6. The method of claim 1, wherein the content privacy setting is togglable via a user interface element that is activated in response to a user opening the private application window.

7. The method of claim 1, wherein the content privacy setting is enabled by placing an icon associated with the private application window in a designated area within the desktop environment.

8. The method of claim 1, wherein the content capture is stored in an input cache prior to consumption by an artificial intelligence model and the method further comprises additionally redacting additional visual content in response to receiving an activation of another content privacy setting associated with another one of the plurality of application windows following generation of the content capture.

9. The method of claim 1, wherein the content privacy setting is an operating system-level digital rights management utility.

10. The method of claim 1, wherein:
the respective display of visual content within the application window is defined by a render buffer;
retrieving the respective display of visual content of the application window comprises querying the render buffer; and
redacting the respective display of visual content within the private application window comprises modifying the render buffer for the private application window.

11. The method of claim 10, wherein modifying the render buffer for the private application window to redact the respective display of visual content comprises emptying the render buffer.

12. A system for redacting visual content in a content capture, the system comprising:
a processing system; and
a computer-readable medium having encoded thereon that, when executed by the processing system, causes the system to perform operations comprising:
receiving a command to generate the content capture, wherein:
the content capture depicts a desktop environment including a private application window; and
the private application window includes a display of visual content;
in response to the command, retrieving the display of visual content of the private application window within the desktop environment by querying the private application window;
in response to detecting a content privacy setting utilized by the private application window, redacting the respective display of visual content within the private application window; and
compositing the redacted visual content to generate the content capture.

13. The system of claim 12, wherein the private application window that utilizes the content privacy setting includes a visual indicator communicating a status of the content privacy setting.

14. The system of claim 12, wherein the content privacy setting is togglable via a context menu option within the private application window.

15. The system of claim 12, wherein the content privacy setting is enabled by placing an icon associated with the private application window in a designated area within the desktop environment.

16. The system of claim 12, wherein:
the private application window is a first application window;
the content privacy setting is a first content privacy setting;
the content capture is stored in an input cache prior to consumption by an artificial intelligence model; and
the operations further comprise redacting additional visual content in response to receiving an activation of a second content privacy setting associated with a second application window following generation of the content capture.

17. The system of claim 12, wherein:
the display of visual content within the private application window is defined by a render buffer;
retrieving the display of visual content of the private application window comprises querying the render buffer; and
redacting the display of visual content within the private application window comprises modifying the render buffer for the private application window.

18. The system of claim 17, wherein modifying the render buffer for the private application window to redact the respective display of visual content comprises emptying the render buffer.

19. A computer-readable storage medium for redacting visual content in a content capture, the computer-readable storage medium having encoded thereon, computer-readable instructions that, when executed by a system, cause the system to perform operations comprising:
receiving a command to generate the content capture, wherein:
the content capture depicts a desktop environment including a plurality of application windows, wherein the plurality of application windows include a private application window; and
an application window includes a respective display of visual content within the application window;
in response to the command, retrieving the respective displays of visual content of the plurality of application windows within the desktop environment by querying the plurality of application windows;
in response to detecting a content privacy setting utilized by a private application window, redacting the respective display of visual content within the private application window; and
compositing the visual content retrieved from the plurality of application windows including the redacted visual content to generate the content capture.

20. The computer-readable storage medium of claim 19, wherein the private application window that utilizes the content privacy setting includes a visual indicator communicating a status of the content privacy setting.
